(19) United States
(12) Patent Application Publication
(10) Pub. No.: US 2004/0041661 A1
(43) Pub. Date: Mar. 4, 2004

(54) Dielectric filter, communication apparatus, and method of controlling resonance frequency

(76) Inventors: Takehiko Yamakawa, Osaka (JP); Toshio Ishizaki, Hyogo (JP); Minoru Tachibana, Osaka (JP)

Correspondence Address: RATNERPRESTIA, P O BOX 980, VALLEY FORGE, PA, 19482-0980, US

(21) Appl. No.: 10/459,671

(22) Filed: Jun. 11, 2003

(30) Foreign Application Priority Data
Jun. 12, 2002 (JP) 2002-172026

(51) Int. Cl. H01P 1/213; H01P 1/20

(52) U.S. Cl. 333/134; 333/202

(57) ABSTRACT

The invention provides a dielectric filter including a metal case having an opening in the upper part, a metal lid of closing the opening, a dielectric resonance element placed on the internal bottom face of the case through a support, a bolt made of dielectric material inserted in a position in the lid corresponding to the dielectric resonance element, and a metal plate placed at the end of the bolt substantially in parallel with the upper face of the dielectric resonance element, wherein the position of the bolt is adjusted to change the space between the dielectric resonance element and the plate, whereby the resonance frequency is controlled.

### BACKGROUND OF THE INVENTION

1. Field of the Invention

The present invention relates to a dielectric filter that is used in a mobile communication base station such as a cellular phone, a broadcast radio wave transmission station and the like, and a communication apparatus using the dielectric filter.

2. Related Art of the Invention

In recent years, high-sensitivity send/receive characteristics and satisfactory speech quality have become essential in cellular phone systems, and low-loss passage characteristics with almost no degradation of signal components and steep-attenuation characteristics capable of reliably removing undesired disturbing wave components are required for filters in the base station. Filters satisfying such demands include a dielectric filter using a dielectric resonator having a high Q value (e.g. see James K. Plourde, Application of Dielectric Resonators in Microwave Components, “IEEE TRANSACTION ON MICROWAVE THEORY AND TECHNIQUES”, IEEE, August, 1981 vol. MTT-29, No. 8, p.754-p. 769.). The entire disclosure of the above document are incorporated herein by reference by its entirety.

One example of a conventional dielectric filter will be described with reference to the drawings. FIG. 13 shows a dielectric filter 1000 in which TE₀₁δ resonance mode dielectric resonators are four-stage connected (the TE₀₁δ resonance mode represents a basic resonance mode). In this dielectric filter 1000, four cavities (spaces) are formed by a metal case 1001 forming a shield box, a metal partition plate 1002 and a metal lid 1003, and dielectric resonance elements 1005a to 1005d are bonded on the bottom surface of the case 1001 through a support 1004 with each dielectric resonance element located at almost the center of each cavity. The support 1004 is made of dielectric material of low radio frequency wave loss such as alumina.

A coupling window 1010 formed by providing a space between the partition plate 1002 and the case 1001 is provided between the partition plate 1002 and the side face of the case 1001. Input/output terminals 1007a and 1007b are attached to the both ends of the cavities communicating through the coupling window 1010, and input/output probes 1008a and 1008b for electromagnetic field coupling with dielectric resonance elements 1005a and 1005d are provided for the internal conductors of the input/output terminals 1007a and 1007b, respectively. The dielectric resonance elements 1005a to 1005d are electromagnetic field-coupled via the coupling window 1010. The magnitude of this coupling is dependent on the size of the coupling window 1010, and is finely adjusted by moving toward or away from the partition plate 1002a coupling adjusting screw 1009 extending to the coupling window of each partition plate 1002. Also, tuning means 1012 constituted by a metal bolt 1006 and a metal plate 1007 for adjusting the resonance frequency is provided in the lid 1003 in correspondence with the positions of the dielectric resonance elements 1005a to 1005d.

When a signal is inputted from the input/output terminal 1007a, the input/output probe 1008a and the dielectric resonance element 1005a are first electromagnetic field-coupled. Then, the dielectric resonance element 1005a and the dielectric resonance element 1005b placed in the adjacent cavity are electromagnetic field-coupled via the coupling window 1010, and the dielectric resonance element 1005b and the dielectric resonance element 1005c, the dielectric resonance element 1005c and the dielectric resonance element 1005d, and the dielectric resonance element 1005d and the input/output probe 1008b are electromagnetic field-coupled, respectively, and the signal is outputted from the input/output terminal 1007b. By adjusting the strength of each respective electromagnetic coupling, and adjusting the space between the plate 1007 of each tuning means 1012 and the upper face of each of the dielectric resonance elements 1005a to 1005d, the resonance frequency of each of the dielectric resonance elements 1005a to 1005d, and thus desired characteristics of the dielectric filter 1000 as a bandpass filter are achieved.

FIG. 16 is a perspective view of a conventional single TE₀₁δ resonance mode dielectric filter 1100. It has a structure in which a cavity is formed by a metal case 1101 and a metal lid 1102, and a dielectric resonance element 1104 is bonded to the case 1101 through a support 1103 with the dielectric resonance element 1104 located at almost the center of the cavity as in the case of the four-stage filter. The resonance frequency of the dielectric resonance element 1104 is adjusted by tuning means 1012. When a signal is inputted from an input/output terminal 1106a, an input/output probe 1107a and a dielectric resonance element 1104 are electromagnetic field-coupled. Then, the dielectric resonance element 1104 and an input/output probe 1107b are electromagnetic field-coupled, and the signal is outputted from an input/output terminal 1106b.

However, the configuration described above has a disadvantage that an undesired resonance mode (spurious) other than a desired resonance mode (TE₀₁δ resonance mode) occurs on the high-pass side of the filter pass band, thus allowing an undesired signal to pass through.

In particular, the spurious due to insertion of tuning means 1012 appears near the TE₀₁δ resonance mode. For example, FIG. 17 shows how the resonance frequency of the TE₀₁δ resonance mode and the resonance frequency of the spurious are changed when the tuning means 1012 is moved down and inserted into the case 1101 in a single resonance filter 1100 (FIG. 16).

The single resonance filter 1100 shown in FIG. 16 is constituted by a metal case 1101, a metal lid 1102, input/output terminals 1106a and 1106b, input/output probes 1107a and 1107b, a dielectric resonance element 1104, a support 1103 and tuning means 1012.

As apparent from FIG. 17, a conventional dielectric filter 1000 has a disadvantage that when a plate 1007 is brought close to the dielectric resonance element 1104 with the tuning means 1012 inserted therein (i.e. the insertion length of a bolt 1006 is increased), in particular, the spurious is close or identical to the resonance frequency of the TE₀₁δ resonance mode, thus making it impossible to achieve desired filter characteristics.

Also, the conventional dielectric filter 1000 has a disadvantage that the spurious cannot be sufficiently shielded in the electromagnetic coupling between adjacent dielectric resonance elements with a coupling window 1010 formed by providing a space between a partition plate 1002 and the side face of the case 1001.

In addition, there is a disadvantage that the influence of the spurious also becomes significant in the electromagnetic coupling between dielectric resonance elements as a coupling adjusting screw 1009 is inserted into the coupling window 1010.

### SUMMARY OF THE INVENTION

In view of the problems described above, the present invention has as its object the provision of a dielectric filter of low-spurious characteristics capable of securing a, sufficient amount of attenuation on the high-pass side of the passband.

The 1^{st} aspect of the present invention is a dielectric filter comprising:

a metal case having an opening in the upper part;

a metal lid of closing said opening;

a dielectric resonance element placed on the internal bottom face of said case through a support;

insertion means made of dielectric material inserted in a position in said lid corresponding to said dielectric resonance element; and

a metal plate placed at the end of said insertion means substantially in parallel with the upper face of said dielectric resonance element,

wherein the position of said insertion means is adjusted to change the space between said dielectric resonance element and said plate, whereby the resonance frequency is controlled.

The 2^{nd} aspect of the present invention is the dielectric filter according to the 1^{st} aspect, wherein said insertion means and said plate are fixed to each other using a screw made of dielectric material.

The 3^{rd} aspect of the present invention is the dielectric filter according to the 2^{nd} aspect, wherein said screw is a screw protrusion placed on said plate.

The 4^{th} aspect of the present invention is the dielectric filter according to the 1^{st} aspect, wherein said plate is fixed to said insertion means by bonding.

The 5^{th} aspect of the present invention is a dielectric filter comprising:

a metal case;

at least one metal partition wall of partitioning the inside of said case into a plurality of spaces; and

dielectric resonance elements each placed on the bottom of each of said plurality of partitioned spaces through a support,

wherein for at least one of said partition walls partitioning adjacent spaces, a notch is provided in an area other that the area facing the side face of said case to form a coupling window of coupling said adjacent spaces.

The 6^{th} aspect of the present invention is the dielectric filter according to the 5^{th} aspect, further comprising a metal plate placed above said dielectric resonance element,

wherein said notch is provided on the side of said partition wall where said support is placed.

The 7^{th} aspect of the present invention is the dielectric filter according to the 5^{th} aspect, a metal coupling adjusting member of adjusting the strength of coupling between said adjacent dielectric resonance elements is inserted in said coupling window from said side face, and said coupling adjusting member is insulated from said side face.

The 8^{th} aspect of the present invention is the dielectric filter according to the 5^{th} aspect, said coupling window is rectangular.

The 9^{th} aspect of the present invention is a dielectric filter comprising:

a metal case having an opening in the upper part;

a metal lid of closing said opening;

at least one metal partition wall of partitioning the inside of said case into a plurality of spaces; and

dielectric resonance elements each placed on the bottom of each of said plurality of partitioned spaces-through a support,

wherein a notch formed by providing a space between the side face of said case and at least part of said partition wall is formed in at least one of said partition walls partitioning adjacent spaces, and

a metal coupling adjusting member of adjusting the strength of coupling between said adjacent dielectric resonance elements is inserted in a position on the side face of said case corresponding to said notch, and said coupling adjusting member is insulated from said side face.

The 10^{th} aspect of the present invention is the dielectric filter according to the 5^{th} aspect, further comprising:

insertion means made of dielectric material inserted in a position located in the upper part of said metal case and corresponding to said dielectric resonance element; and

a metal plate placed at the end of said insertion means substantially in parallel with the upper face of said dielectric resonance element,

wherein said insertion means is adjusted to change a space between said dielectric resonance element and said plate, whereby the resonance frequency is controlled.

The 11^{th} aspect of the present invention is a dielectric filter comprising:

a metal case;

a dielectric resonance element placed on the internal bottom face of said case through a support;

insertion means inserted in a position located in the upper part of said metal case and corresponding to said dielectric resonance element;

a metal plate placed at the end of said insertion means substantially in parallel with the upper face of said dielectric resonance element; and

a metal ring-shaped material run through said insertion means between the face of said metal case in which said insertion means is inserted and said plate.

The 12^{th} aspect of the present invention is the dielectric filter according to the 1^{st} aspect, wherein said dielectric material has a relative dielectric constant of 10 or smaller.

The 13^{th} aspect of the present invention is a communication apparatus comprising a transmission apparatus and a reception apparatus,

wherein at least one of said transmission apparatus and reception apparatus comprises the dielectric filter according to any of the 1^{st}, 5^{th}, 9^{th} and 11^{th} aspects.

The 14^{th} aspect of the present invention is a method of controlling a resonance frequency using a dielectric filter comprising:

a metal case having an opening in the upper part;

a metal lid of closing said opening;

a dielectric resonance element placed on the internal bottom face of said case through a support;

insertion means made of dielectric material inserted in a position in said lid corresponding to said dielectric resonance element; and

a metal plate placed at the end of said insertion means substantially in parallel with the upper face of said dielectric resonance element,

wherein the position of said insertion means is adjusted to change the space between said dielectric resonance element and said plate, whereby the resonance frequency is controlled.

### BRIEF DESCRIPTION OF THE DRAWINGS

FIG. 1 is an exploded translucent perspective view of a dielectric filter of Embodiment 1 of the present invention.

FIG. 2 is an exploded translucent perspective view of the dielectric filter of Embodiment 2 of the present invention.

FIG. 3 is an enlarged translucent perspective view of a coupling adjusting screw of the dielectric filter of the embodiment of the present invention.

FIG. 4 is an enlarged translucent perspective view of a coupling window of the dielectric filter of the embodiment of the present invention.

FIG. 5 shows pass characteristics of the dielectric filter of the embodiment of the present invention and the conventional dielectric filter.

FIG. 6 is an exploded perspective view of tuning means of the dielectric filter of the embodiment of the present invention.

FIG. 7 shows changes in TE₀₁δ resonance mode and spurious resonance frequencies of the dielectric filter of Embodiment 1 of the present invention.

FIG. 8 shows changes in TE₀₁δ resonance mode and spurious resonance frequencies of the dielectric filter of the embodiment of the present invention.

FIG. 9 shows changes in TE₀₁δ resonance mode and spurious resonance frequencies of the dielectric filter of the embodiment of the present invention.

FIG. 10 is an exploded perspective view of tuning means of the dielectric filter of the embodiment of the present invention.

FIG. 11 is an enlarged view of tuning means of the dielectric filter of the embodiment of the present invention.

FIG. 12 is a characteristic view of a single resonator of the dielectric filter of the embodiment of the present invention.

FIG. 13 is an exploded translucent perspective view of the conventional dielectric filter.

FIG. 14 is a translucent plan view of the dielectric filter of the present invention.

FIG. 15 is an exploded translucent perspective view of the dielectric filter of the present invention.

FIG. 16 is an exploded translucent perspective view of a single dielectric resonator of the conventional dielectric filter.

FIG. 17 shows the tuning means insertion length and changes in TE₀₁δ resonance mode and spurious resonance frequencies of the single dielectric resonator of the conventional dielectric filter.

FIG. 18 illustrates the operation principle of the dielectric filter of the present invention.

FIG. 19 illustrates the operation principle of the conventional dielectric filter.

FIG. 20 is a block diagram showing an outlined configuration of a communication apparatus of the present invention.

### DESCRIPTION OF SYMBOLS

101, 1001, 1101 Case

102, 1002 Partition plate

103, 1003, 1102 Lid

104, 1004, 1103 Support

105, 1005, 1104 Dielectric resonance element

106, 1006 Bolt

107, 701 Plate

108a, 108b, 1007a, 1007b, 1106a, 1106b Input/output terminal

109a, 109b, 1008a, 1008b, 1107a, 1107b Input/output probe

110, 1009 Coupling adjusting screw

111 Notch

112, 1012 Tuning means

113, 1010 Coupling window

201 Bushing

501 Screw

801 Nut

### PREFERRED EMBODIMENTS OF THE INVENTION

(Embodiment 1)

A dielectric filter of Embodiment 1 of the present invention will be described with reference to the drawings.

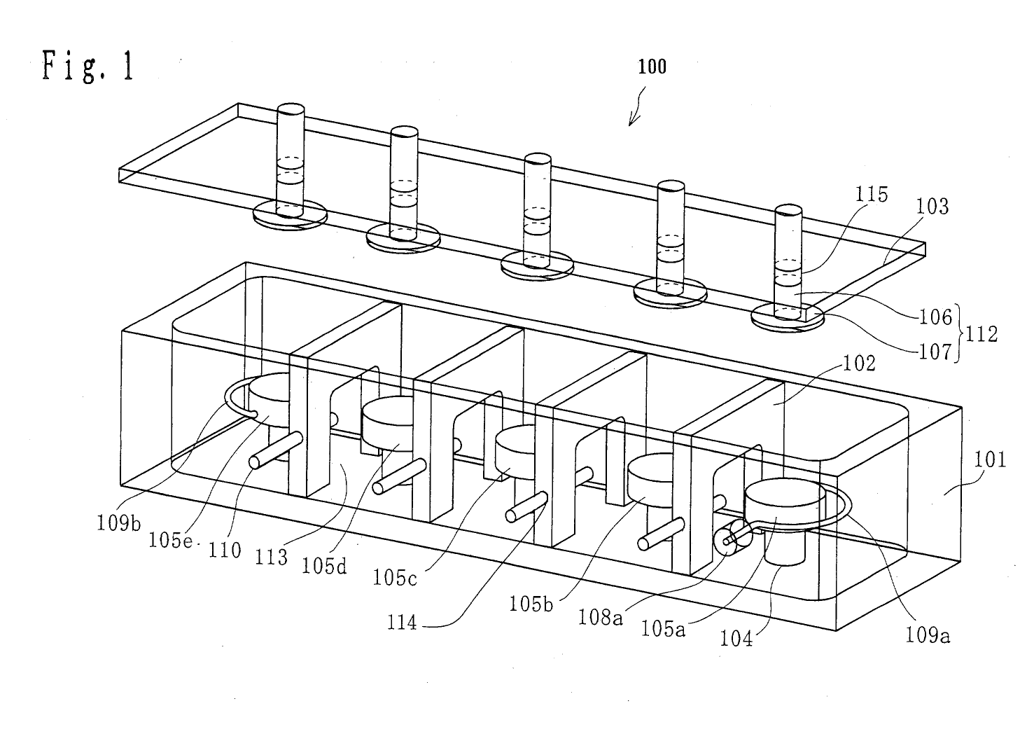

FIG. 1 is an exploded translucent perspective view of a five-stage TE₀₁δ resonance mode bandpass filter (five-stage dielectric filter) 100 in Embodiment 1 of the present invention. In FIG. 1, the five-stage dielectric filter 100 comprises a case 101 being one example of the metal case of the present invention, a partition plate 102 being one example of the partition wall of the present invention, a lid 103 being one example of the metal lid of the present invention, a support 104, dielectric resonance elements 105a to 105e being one example of the dielectric resonance element of the present invention, tuning means 112, input/output terminals 108a and 108b (not shown), input/output probes 109a and 109b, and a coupling adjusting screw 110 being one example of the metal coupling adjusting member of the present invention.

The tuning means 112 has a bolt 106 being one example of insertion means of the present invention and a plate 107 being one example of the metal plate of the present invention. Five cavities (spaces) are formed by the case 101, the partition plate 102 placed in the case 101 and the lid 103, and the dielectric resonance elements 105a to 105e having flat upper faces are each mounted on the bottom face of the case 101 through the support 104 to be located at almost the center of each cavity.

Materials constituting the plate 107, the case 101 and the lid 103 are preferably those of high conductivity such as aluminum, copper, brass, silver, aluminum plated with silver, brass plated with silver and iron plated with silver.

The cavities partitioned by the case 101, the partition plate 102 and the lid 103 communicate through a coupling window 113 formed in the partition plate 102, and the input/output terminals 108a and 108b are attached to the both ends of these cavities. The input/output probes 109a and 109b for electromagnetic coupling with the dielectric resonance elements 105a and 105e are connected to the internal conductors of the input/output terminals 108a and 108b, respectively. The input/output probes 109a and 109b are placed in the close proximity of the dielectric resonance elements 105a and 105e.

In the partition plate 102, a notch is provided in such a manner that it contacts part of the bottom face of the case 101 to form the coupling window 113 of coupling electromagnetically adjacent dielectric resonance elements together. The coupling window 113 is formed in such a manner that it does not contact the side face of the case 101, and the size of the coupling window 113 is dependent on the required magnitude of the coupling between dielectric resonance elements.

On the side face of the case 101, a hole 114 is formed in a position corresponding to the partition plate 102, the coupling adjusting screw 110 (e.g. having a diameter of M2) of finely adjusting the strength of coupling between dielectric resonance elements is inserted through the hole 114, and the coupling adjusting screw 110 penetrates through part of the partition plate 102 to protrude into the coupling window 113.

In the lid 103, holes 115 each provided in its inner face with a thread are formed in correspondence to the positions of dielectric resonance elements 105a to 105e, and the bolt 106 made of polycarbonate being one example of insertion means of the present invention, which is engaged with the thread, is inserted in the hole 115. The plate 107 is provided at one end of each bolt 106 substantially in parallel with the upper face of each dielectric resonance element. In this way, each bolt 106 and plate 107 constitutes the tuning means 112 of adjusting the resonance frequency.

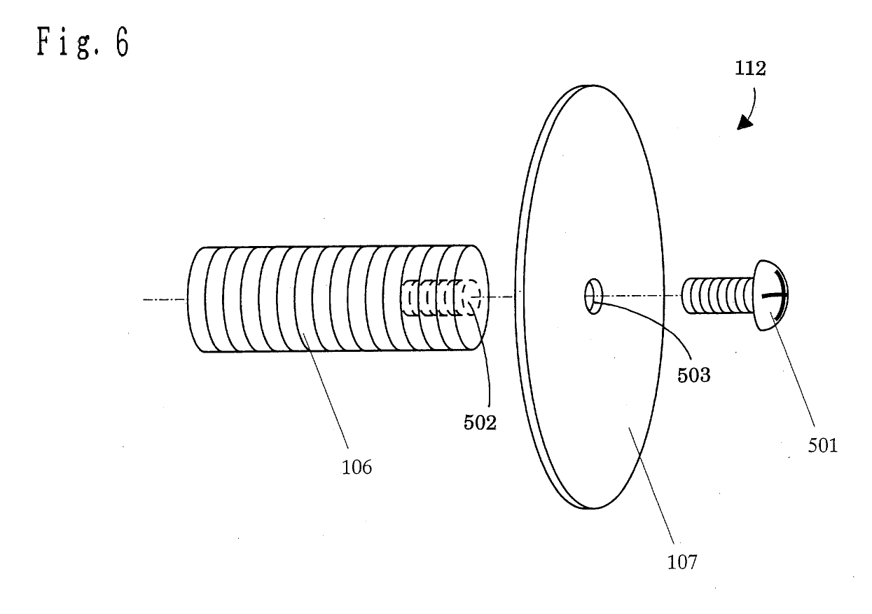

FIG. 6 is an exploded perspective view of the tuning means 112 of FIG. 1. A recess 502 internally provided with a thread for engagement with a screw 501 made of polycarbonate is formed at the end of the bolt 106, and a hole 503 for insertion of the screw 501 is formed at the center of the plate 107. The screw 501 is squeezed into the recess 502 of the bolt 106 through the hole 503 formed in the plate 107, whereby the bolt 106 and the plate 107 are fixed together to fabricate the tuning means 112.

As one example of the dimension of the tuning means 112, the bolt 106 made of polycarbonate has an outer face provided with a thread having a diameter of 4 mm and a pitch of 0.7 mm, and an inner face provided in the recess 502 with a thread having a diameter of 2 mm, a pitch of 0.4 mm and a depth of about 5 mm with the axis shared with the thread with the diameter of 4 mm. The plate 107 is a copper plate having an outer diameter of 10 mm and a thickness of 0.5 mm, and the diameter of the hole 503 is 2.2 mm. These are only one example of the dimension and material, the dimension and material of the tuning means 112 is not limited to those described above.

Operations of the five-stage dielectric filter 100 configured as described above will now be described.

When a signal is inputted from the input/output terminal 108a, the input/output probe 109a and the dielectric resonance element 105a are electromagnetic field-coupled. Then, the dielectric resonance element 105a and the dielectric resonance element 105b placed in the cavity adjacent the cavity in which the dielectric resonance element 105a are electromagnetic field-coupled through the coupling window 113, and the dielectric resonance element 105b and the dielectric resonance element 105c, the dielectric resonance element 105c and the dielectric resonance element 105d, the dielectric resonance element 105d and the dielectric resonance element 105e, and the dielectric resonance element 105e and the input/output probe 109b are electromagnetic field-coupled, respectively, and the signal is outputted from the input/output probe 109b.

At this time, the coupling adjusting screw 110 is adjusted for finely adjusting the strength of each electromagnetic field coupling, and the bolt 106 of the tuning means 112 is rotated to adjust the length of its insertion into the case 101 (i.e. space between the plate 107 and each of the dielectric resonance elements 105a to 105e) to control the resonance frequency.

When the tuning means 112 is adjusted and thereby the plate 107 approaches each dielectric resonance element, the electromagnetic field of TE₀₁δ resonance mode formed in each cavity is depressed, resulting in a situation equivalent to a decrease in the size of the cavity. The resonance frequency is controlled in this way, and thus desired bandpass filter characteristics are achieved.

Since the coupling window 113 is formed in such a manner that it contacts the bottom face of the case 101, the electromagnetic field coupling between adjacent cavities is not significantly weakened even if the electromagnetic field of TE₀₁δ resonance mode is depressed by the plate 107.

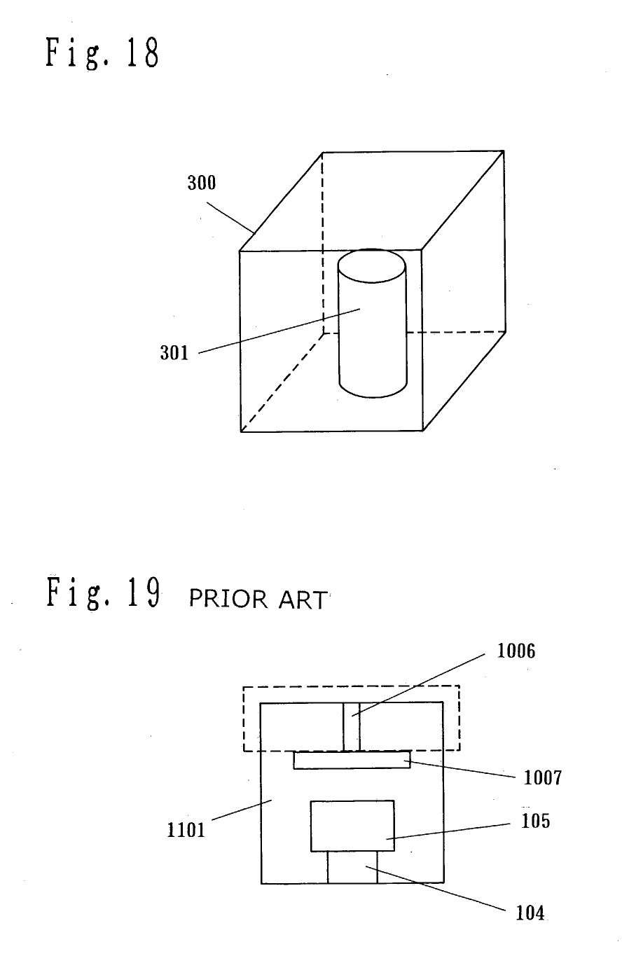

The principle of how the spurious is reduced by the dielectric filter of this embodiment will now be described. FIG. 18 shows a resonator called a semi-coaxial resonator. This semi-coaxial resonator has a metal box 300 and a metal axis unit 301, and the length of the metal axis unit 301 is one quarter of the working wavelength. According to this semi-coaxial resonator, resonance occurs at a frequency having a wavelength equal to one quarter of the working wavelength or an odd multiple thereof.

FIG. 19 shows a cross section of the side face of a conventional dielectric filter 1100. In the conventional dielectric filter 1100, it can be considered that because the bolt 1006 is made of metal, a semi-coaxial resonator or its altered mode dictated by the insertion length of the bolt 1006, and together with the plate 1007, thus spurious components appear as shown by the dashed line in FIG. 19. According to the dielectric filter 100 of this embodiment, however, the bolt 106 made of dielectric material is used instead of the metal bolt 1006, and therefore the semi-axial resonator as shown by the dashed line in FIG. 19 is less likely formed. Also, the coupling window 113 is formed in such a manner that it contacts the bottom face of the case 101. In other words, the coupling window 113 is formed at a location away from the plate 107 on the partition plate 102. Thus, the rate at which the spurious is transferred to the adjacent cavities is low even if the spurious is generated. In this way, in general, the ratio of the undesired spurious to the desired TE₀₁δ resonance mode is reduced.

Also, in the dielectric filter of this embodiment, the bolt 106 and the plate 107 are coupled together by the screw 501 made of polycarbonate, and therefore there is no possibility that the spurious is generated due to the influence of the screw 501. That is, if the screw 501 is made of metal, a semi-coaxial resonator is formed by the metal screw 501 and the plate 107, and the spurious associated with the insertion length of the metal screw 501 is generated, but such a spurious is not generated in the dielectric filter of the present invention.

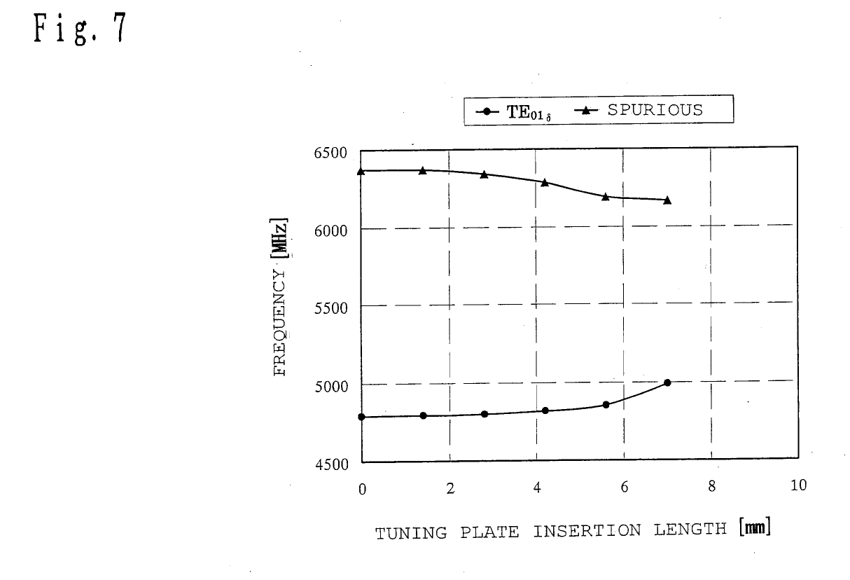

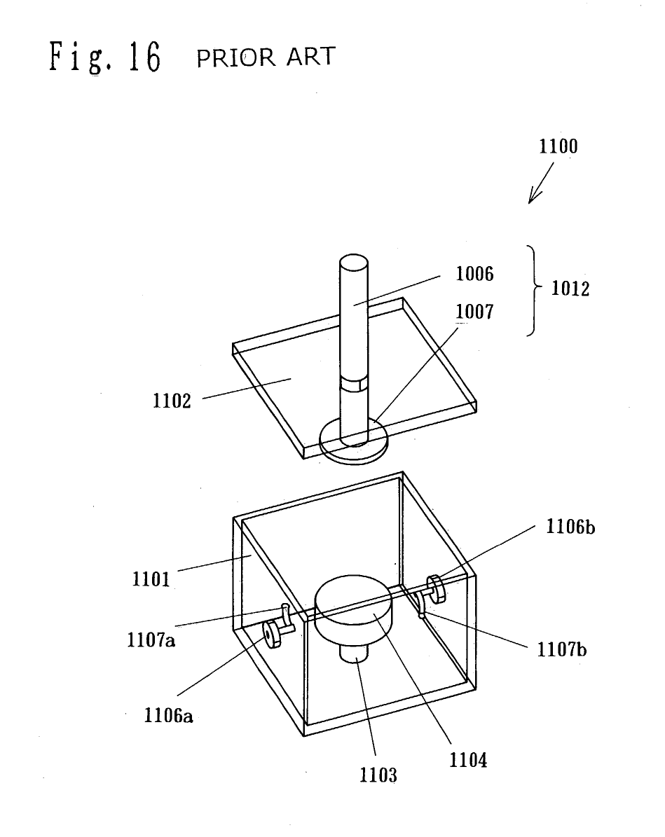

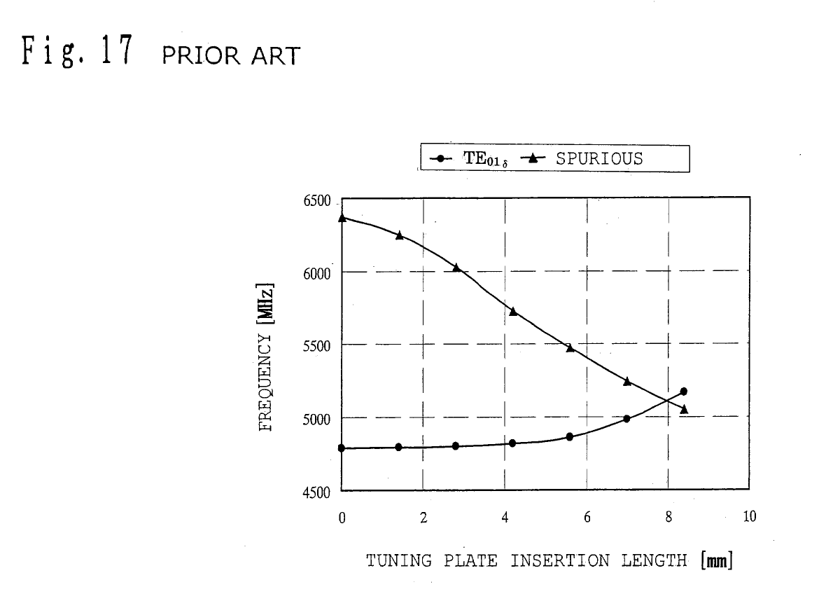

FIG. 7 shows how the TE₀₁δ resonance mode resonance frequency and the spurious resonance frequency change with the insertion length of the bolt 106 when the tuning means 1012 is changed to the tuning means 112 described above in the single resonance filter shown in FIG. 16. As apparent from FIG. 7, according to the single resonance filter using the tuning means 112, the spurious resonance frequency almost never approaches the TE₀₁δ resonance mode resonance frequency even if the bolt is inserted so that the tuning means 112 is brought into close proximity to the dielectric resonance element 1104. The dielectric resonance filter 100 of this embodiment has these single resonance filters stacked in four stages, and therefore the same effect can be obtained in the dielectric resonance filter 100.

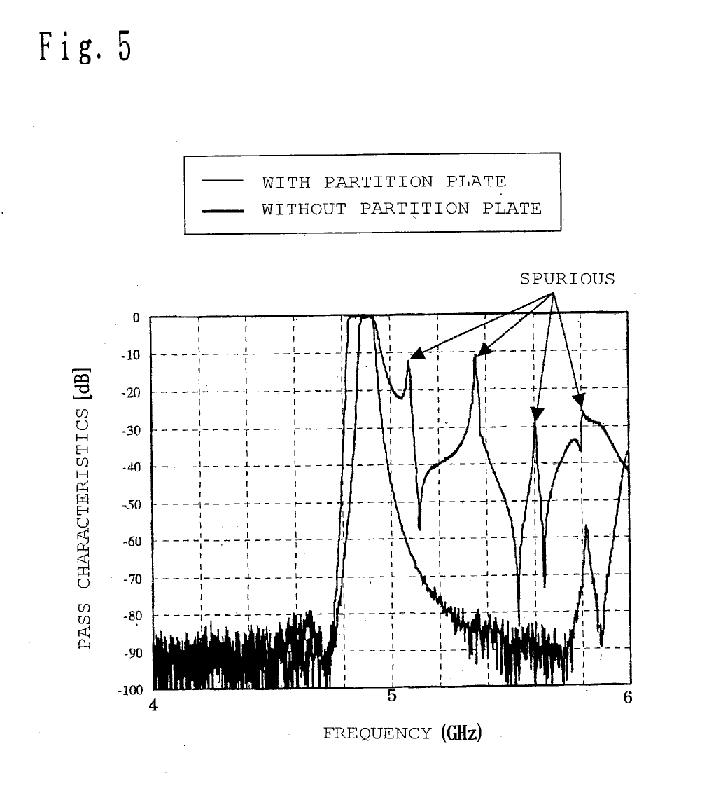

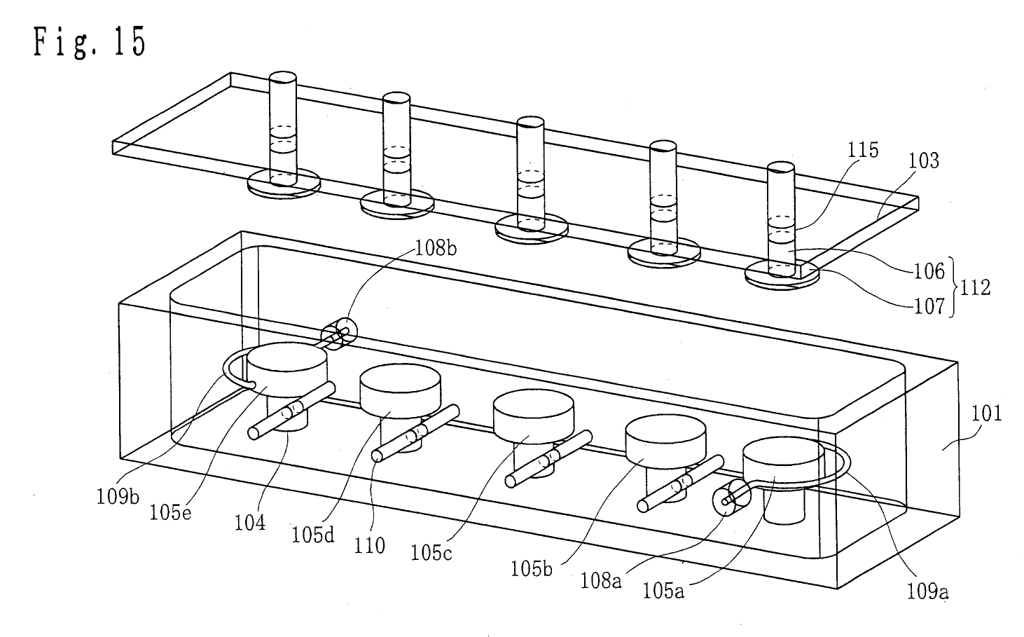

FIG. 5 shows a comparison of the frequency pass characteristics of the dielectric filter 100 of this embodiment and the frequency pass characteristics of the dielectric filter having no partition plate 102 shown in FIG. 15. Other conditions are the same. In FIG. 5, the narrow line shows the frequency pass characteristics of the dielectric filter of this embodiment, and the wide line shows the frequency pass characteristics of the dielectric filter having no partition plate 102. As apparent from FIG. 5, a large amount of spurious occurs in the frequency pass characteristics in which no partition plate 102 is used, while the spurious is considerably reduced when the partition plate 102 is used. That is, it can be understood that the spurious can be effectively reduced by forming the coupling window 113 in such a manner that it does not contact the side face of the case 101.

As described above, according to the dielectric filter of this embodiment, the coupling window 113 dictating the coupling between dielectric resonance elements is formed on the partition plate 102 in such a manner that it does not contact the side face of the case 101, whereby a resonance mode (spurious) other than a desired resonance mode can be reduced.

Also, according to the dielectric filter of this embodiment, the pole (bolt 106) of the tuning means 112 of adjusting the resonance frequency of the dielectric resonator is used as a dielectric (insulator), whereby the spurious appearing when the tuning means 112 is moved down is prevented from being brought into close proximity to a desired resonance mode.

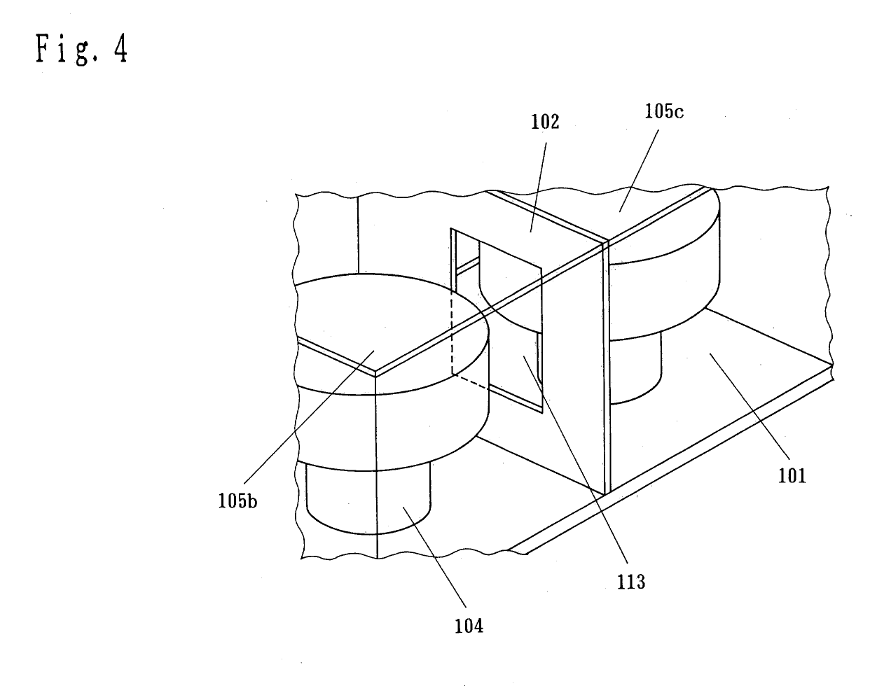

Furthermore, in the description of the above embodiment, the coupling window 113 is formed in such a manner that it contacts part of the bottom face of the case 101 and does not contact the side face of the case 101, but the coupling window 113 may be formed in such a manner that it contacts the entire bottom face, or may be formed in a different form. For example, the coupling window 113 may be formed in such a manner that it contacts the lid 103 and does not contact the side face of the case 101, or may be formed in such a manner that it contacts another partition plate 102. Also, the coupling window 113 may be enclosed on the partition plate 102 as shown in FIG. 4. That is, any form of coupling window can bring about the same effect as described above as long as the coupling window 113 is formed in such a manner that it does not contact the side face of the case 101.

Also, in the embodiment described above, the dielectric filter has as its components the bolt 106 made of dielectric material and the coupling window 113 formed in such a manner that it does not contact the side face of the case 101, but the dielectric filter may have only one of these components.

That is, only the bolt 1006 of the tuning means 1012 in the dielectric filter 1000 of the prior art may be changed to the bolt 106 of the dielectric filter 100 in the embodiment described above, or only the partition plate 1002 having the coupling window 1010 in the dielectric filter 1000 of the prior art may be changed to the partition plate 102 having the coupling window 113 in the embodiment described above. The same effect as described above can be obtained even when this dielectric filter is used.

(Embodiment 2)

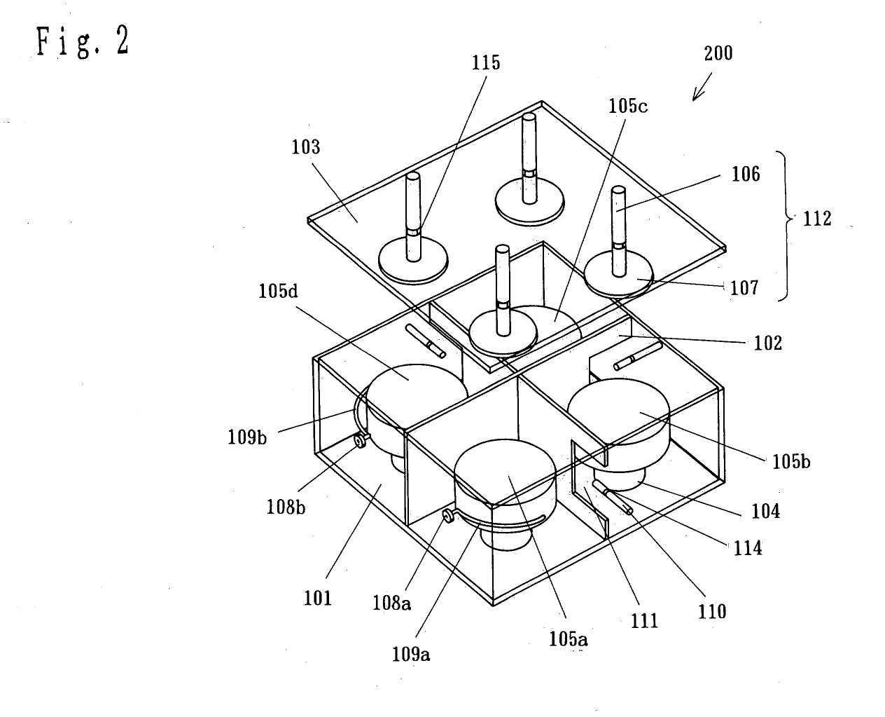

FIG. 2 is an exploded translucent perspective view of a four-stage TE₀₁δ resonance mode bandpass filter (four-stage dielectric filter) 200 in Embodiment 2. In FIG. 2, components same as those of the five-stage dielectric filter 100 of Embodiment 1 are given like reference symbols, and the description thereof is omitted. The four-stage dielectric filter 200 of this embodiment comprises dielectric resonance elements 105a to 105d being one example of the dielectric resonance element of the present invention. In the four-stage dielectric filter of this embodiment, four cavities (spaces) are formed in such a manner that each cavity adjoins other two cavities by a case 101, a partition plate 102 placed in the case 101 and a lid 103, and the dielectric resonance elements 105a to 105d having flat upper faces are each mounted on the bottom face of the case 101 through a support 104 to be located at almost the center of each cavity.

In the partition plate 102, a notch 111 is formed in such a manner that it contacts the side face of the case 101. However, the notch 111 is not formed in the area of the partition plate 102 between the dielectric resonance element 105a connected to an input/output terminal 108a and the dielectric resonance element 105d connected to an input/output terminal 108b. The notch 111 is formed in such a manner that it contacts the side face of the case 101.

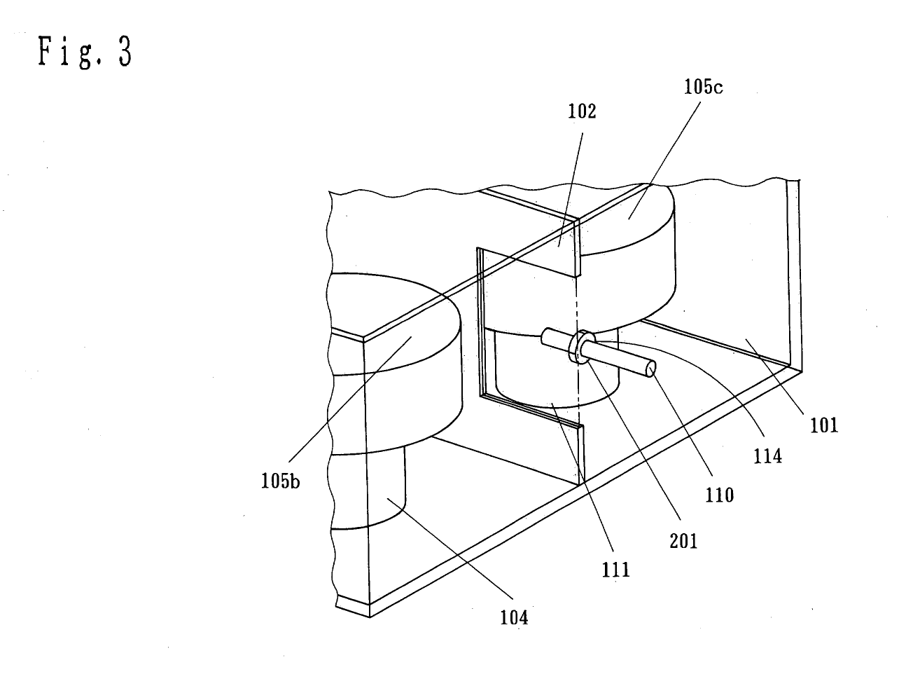

A hole 114 is formed in a position on the side face of the case 101 corresponding to the notch 111, and a coupling adjusting screw 110 (e.g. having a diameter of M2) of adjusting the strength of coupling between dielectric resonance elements is inserted through the hole 114. A bushing 201 made of polycarbonate provided with a thread matched with the coupling adjusting screw 110 is inserted in the hole 114 (e.g. having a diameter of M4) as shown in FIG. 3, and the coupling adjusting screw 110 is thereby supported. That is, the metal case 101 and the metal coupling adjusting screw 110 are electrically insulated from each other by the bushing 201.

Operations of the four-stage dielectric filter configured as described above will now be described.

When a signal is inputted from the input/output terminal 108a, the input/output probe 109a and the dielectric resonance element 105a are electromagnetic field-coupled. Then, the dielectric resonance element 105a and the dielectric resonance element 105b placed in the cavity adjacent to the cavity in which the dielectric resonance element 105a are electromagnetic field-coupled through the notch 111, and the dielectric resonance element 105b and the dielectric resonance element 105c, the dielectric resonance element 105c and the dielectric resonance element 105d, and the dielectric resonance element 105d and the input/output probe 109b are electromagnetic field-coupled, respectively, and the signal is outputted from the input/output probe 108b.

At this time, the coupling adjusting screw 110 is adjusted for finely adjusting the strength of each electromagnetic field coupling, and a bolt 106 of tuning means 112 is rotated to adjust the insertion length into the case 101 (i.e. space between the plates 107 and each of the dielectric resonance elements 105a to 105d) for controlling the resonance frequency. In this way, desired bandpass filter characteristics are achieved.

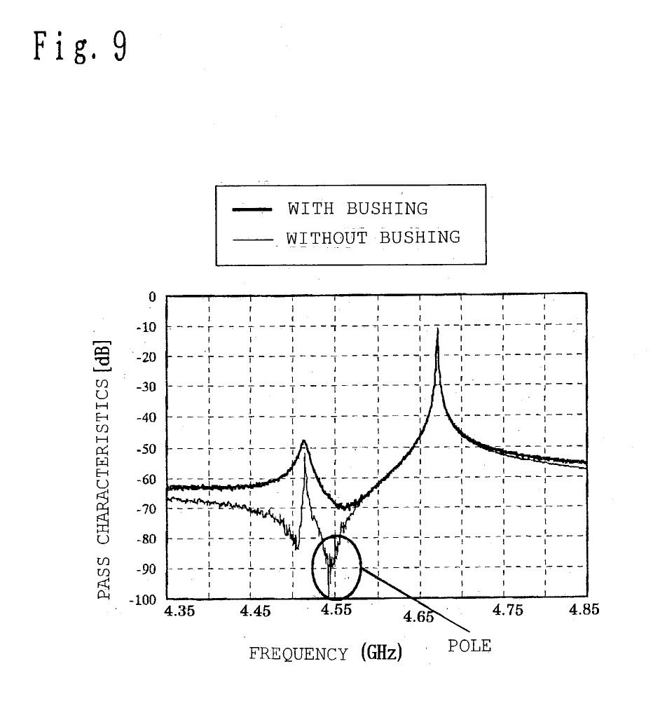

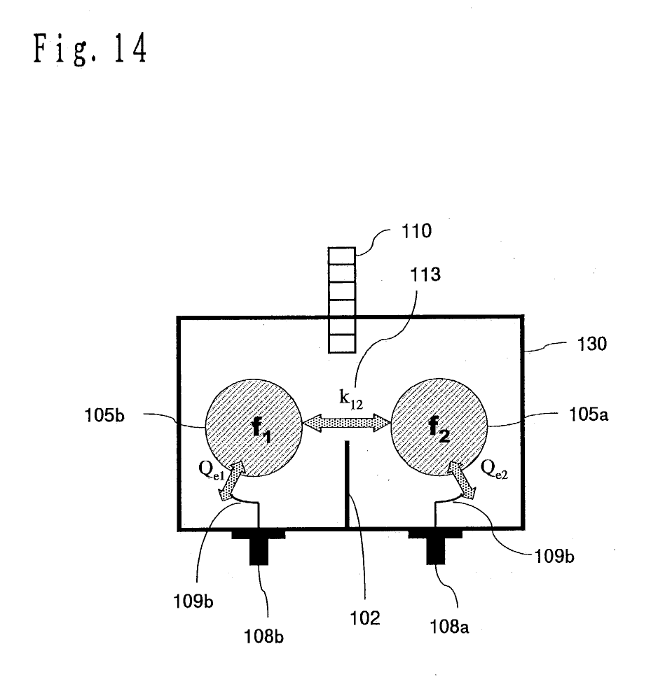

FIG. 9 shows a comparison of the frequency pass characteristics when the coupling adjusting screw 110 is not supported by the bushing 201 made of dielectric material but supported directly on the metal case 101 and the frequency pass characteristics when the coupling adjusting screw 110 is supported by the bushing 201. This data shows characteristics for existence of the bushing 201 versus characteristics for nonexistence of the bushing 201 when the two-stage dielectric filter shown in FIG. 14 is used, the lengths of input/output probes 109a and 109b are decreased to reduce the coupling, and the coupling adjusting screw 110 is inserted to the depth of 9 mm. Same components as those of the dielectric filter shown in FIG. 2 are used. Also, for the coupling adjusting screw 110, a copper screw is used, and it is inserted into the metal case 130 to the depth of 9 mm to make measurements.

As apparent from FIG. 9, occurrence of the undesired spurious. (e.g. area shown as a pole in FIG. 9) can be inhibited more effectively when the bushing 201 is used. That is, the spurious is more effectively inhibited when the coupling adjusting screw 110 is electrically insulated from the metal case 101.

As described above, according to the dielectric filter of the present invention, the metal coupling adjusting screw 110 of adjusting inter-stage coupling between dielectric resonance elements is connected to the metal case through the bushing 201 made of polycarbonate, whereby the spurious appearing when the coupling adjusting screw 110 is inserted in the case 101 can be prevented being brought into close proximity to a desired resonance mode.

Furthermore, in this embodiment, the material of the bushing 201 is not limited to polycarbonate, and any other materials having good high-frequency characteristics may be used.

Also, in the embodiment described above, the dielectric filter has as its components the bolt 106 made of dielectric material, and the bushing 201 made of dielectric material for supporting the coupling adjusting screw 110 on the side face of the case 101, but it may have a configuration in which the bushing 201 made of dielectric material for supporting the coupling adjusting screw is used in the dielectric filter 1000 of the prior art.

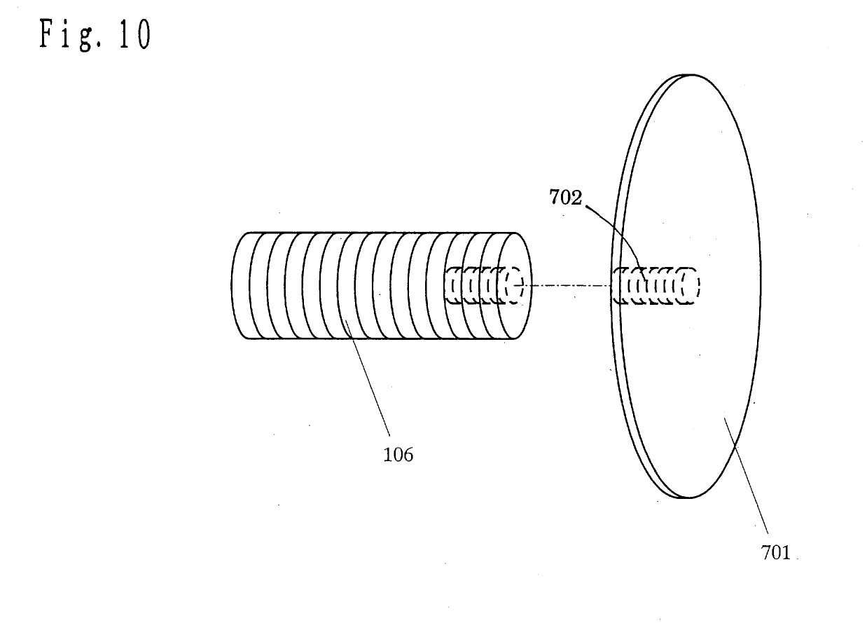

Also, in the above description, the tuning means 112 is such that the plate 107 is screw-fixed to the bolt 106 by the screw 501, but as shown in FIG. 10, it may have a structure in which a screw protrusion 702 is attached to the central portion of a plate 701 by bonding or the like. In this way, the number of parts can be reduced.

The bolt 106 may be bonded to the plate 107 with no recess provided in the bolt 106 and with no hole provided in the plate 107. In this way, the number of parts can further be reduced, thus making it possible to achieve a cost reduction.

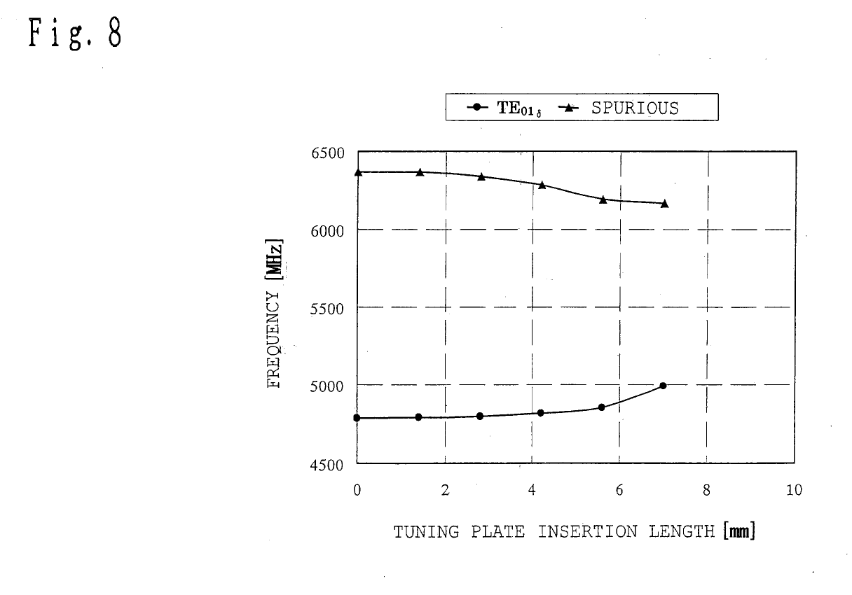

Also, in the above description, polycarbonate is used as a material of the bolt 106, but the same effect can be obtained even if any other nonmetal dielectric material having good high-frequency characteristics (e.g. dielectric loss tangent of 0.001 or smaller) such as syndiotactic polystyrene is used. FIG. 8 shows how the TE₀₁δ resonance mode resonance frequency and the spurious resonance frequency change with the insertion length of the bolt 106 when a polyphenylene sulfide resin is used as the material of the bolt 106. As apparent from FIG. 8, the TE₀₁δ resonance mode resonance frequency and the spurious resonance frequency are almost no longer closer to each other even in the high-frequency range.

Also, in the above description, the tuning means 112 is constituted by the bolt 106 and the plate 107, and is inserted in the hole 115 formed in the lid 103, and by rotating the bolt 106, the distance between the plate 107 and each dielectric resonance element is adjusted to control the resonance frequency of each dielectric resonance element, but it is also conceivable that an axis member provided with no thread is used instead of the bolt 106. In this case, the insertion length of this axis member into the case 101 may be adjusted using, for example, a vernier gear.

Also, in the above description, examples in which the dielectric filters 100, 200 of the embodiments of the present invention have a structure of cavities formed in series in the case 101 by the partition plates 102, or a structure of four cavities partitioned by the intersecting partition plates 102 in the case 101 have been described, but the present invention is not limited to the examples, but cavities may be provided in other forms, and any structure may be used as long as dielectric resonance elements placed in cavities are electromagnetically coupled through the coupling window (or notch) formed in the partition plate.

Also, needless to say, the number of cavities partitioned by the partition plates 102 in the case 101 is not limited to the number described in the above example, but the case 101 may be partitioned into any number of cavities.

Also, in the above description, the case 101 of the dielectric filter is rectangular, but the case 101 may have any shape such as, for example, a cylindrical shape as long as it is capable of placing therein dielectric resonance elements, tuning means, coupling adjusting screws and the like.

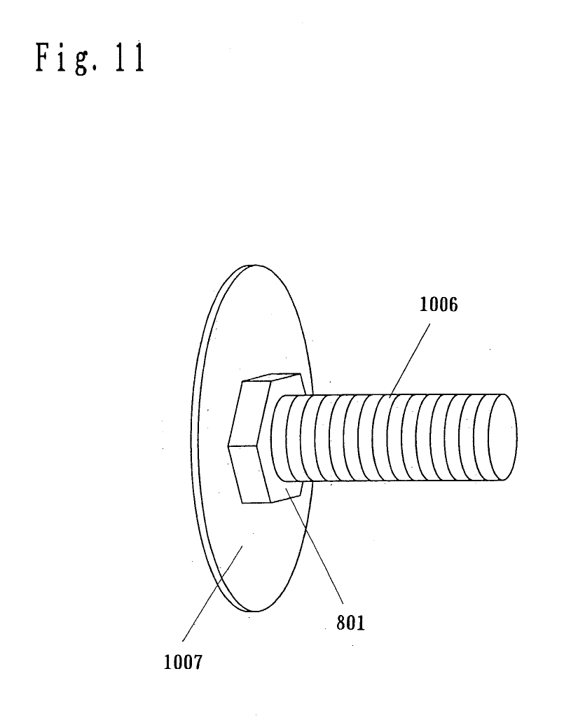

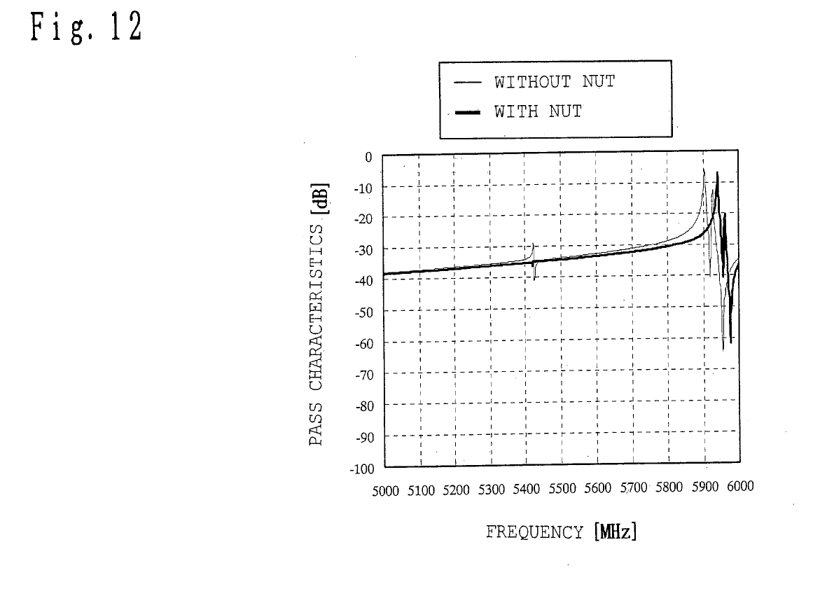

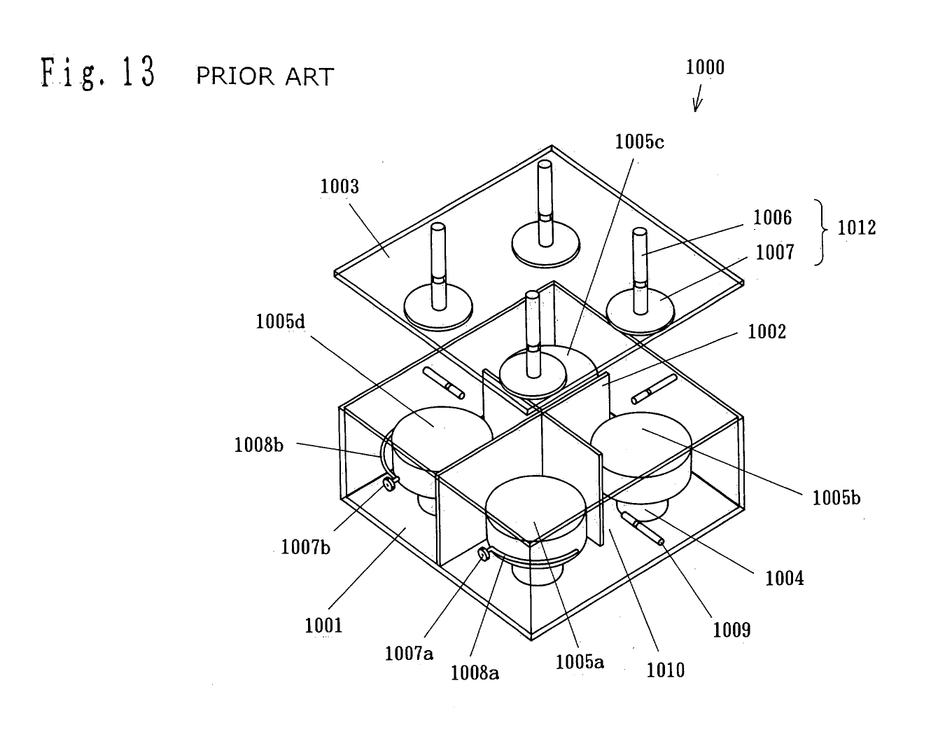

Also, there may be cases where a metal nut 801 is inserted between the plate 1007 and the lid 1003 as shown in FIG. 11 when conventional tuning means 1012 is used. By inserting the metal nut 801 in this way, generation of the spurious by a semi-coaxial resonator formed by the bolt 1006 and the plate 1007 is inhibited. The characteristics of the single resonance filter at this time are shown in FIG. 12. The narrow line shows the frequency pass characteristics when the nut 801 does not exist, and the wide line shows the frequency pass characteristics when the nut exists. As apparent from FIG. 12, the spurious frequency is shifted to the high-pass range in the pass characteristics of the single resonance filter when the nut 801 is inserted. In this way, the spurious can easily be isolated from the passband.

Furthermore, one or more nuts 801 may be used as necessary. The same effect can be obtained even if a metal body such as a ring-shaped metal is used instead of the nut.

Also, in the above description, the dielectric filter of the present invention comprises the tuning means 112 and the coupling adjusting screw 110, but the filter may have a configuration in which the tuning means 112 or the coupling adjusting screw 110 is absent. In this dielectric filter, the same effect as described above can be obtained.

Also, in the above description, the dielectric filter of the present invention comprises the metal case 101 having an opening in the upper part and the metal lid 103 of closing the opening, and the tuning means 112 is inserted into the lid 103, but the tuning means 112 may be inserted into the upper face of the case with the upper part closed. In this case, the same effect as described above can be obtained.

Also, in the above description, the dielectric filter of the present invention has the partition plate 102 used as a partition wall, but the present invention is not limited to this configuration, and cavities may be arranged in other forms. For example, the dielectric filter may have a configuration in which a plurality of single resonance filters shown in FIG. 16 are arranged, and the side face of the case 1101 of each single resonance filter acts as a partition wall. In this case, the coupling window described above may be formed on each side face.

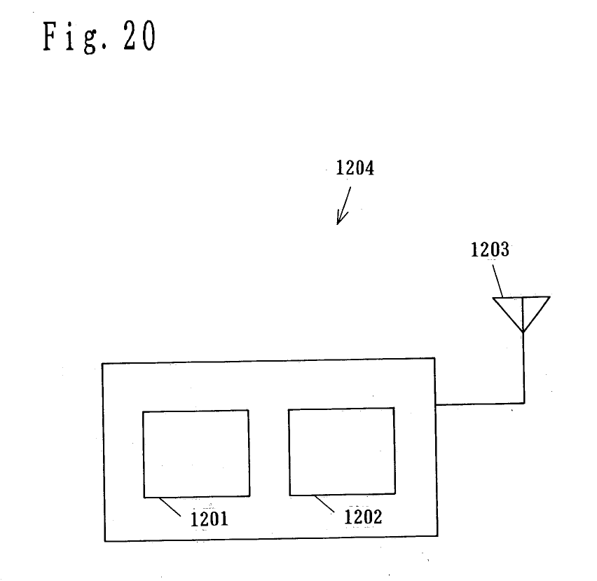

In addition, the dielectric filter itself has been described above, but the present invention also include a communication apparatus 1204 comprising a transmission apparatus 1202 and a reception apparatus 1201, wherein at least one of the transmission apparatus 1202 and the reception apparatus 1201 comprises any of the dielectric filters described above. A schematic block configuration of the communication apparatus 1204 is shown in FIG. 20.

According to the present invention, a dielectric filter of low-spurious characteristics capable of securing a sufficient amount of attenuation on the high-pass side of the passband can be provided.

What is claimed is:

1. A dielectric filter comprising:
a metal case having an opening in the upper part;
a metal lid of closing said opening;
a dielectric resonance element placed on the internal bottom face of said case through a support;
insertion means made of dielectric material inserted in a position in said lid corresponding to said dielectric resonance element; and
a metal plate placed at the end of said insertion means substantially in parallel with the upper face of said dielectric resonance element,
wherein the position of said insertion means is adjusted to change the space between said dielectric resonance element and said plate, whereby the resonance frequency is controlled.

2. The dielectric filter according to claim 1, wherein said insertion means and said plate are fixed to each other using a screw made of dielectric material.

3. The dielectric filter according to claim 2, wherein said screw is a screw protrusion placed on said plate.

4. The dielectric filter according to claim 1, wherein said plate is fixed to said insertion means by bonding.

5. A dielectric filter comprising:
a metal case;
at least one metal partition wall of partitioning the inside of said case into a plurality of spaces; and
dielectric resonance elements each placed on the bottom of each of said plurality of partitioned spaces through a support,
wherein for at least one of said partition walls partitioning adjacent spaces, a notch is provided in an area other that the area facing the side face of said case to form a coupling window of coupling said adjacent spaces.

6. The dielectric filter according to claim 5, further comprising a metal plate placed above said dielectric resonance element,
wherein said notch is provided on the side of said partition wall where said support is placed.

7. The dielectric filter according to claim 5, a metal coupling adjusting member of adjusting the strength of coupling between said adjacent dielectric resonance elements is inserted in said coupling window from said side face, and said coupling adjusting member is insulated from said side face.

8. The dielectric filter according to claim 5, said coupling window is rectangular.

9. A dielectric filter comprising:
a metal case having an opening in the upper part;
a metal lid of closing said opening;
at least one metal partition wall of partitioning the inside of said case into a plurality of spaces; and
dielectric resonance elements each placed on the bottom of each of said plurality of partitioned spaces through a support,
wherein a notch formed by providing a space between the side face of said case and at least part of said partition wall is formed in at least one of said partition walls partitioning adjacent spaces, and
a metal coupling adjusting member of adjusting the strength of coupling between said adjacent dielectric resonance elements is inserted in a position on the side face of said case corresponding to said notch, and said coupling adjusting member is insulated from said side face.

10. The dielectric filter according to claim 5, further comprising:
insertion means made of dielectric material inserted in a position located in the upper part of said metal case and corresponding to said dielectric resonance element; and
a metal plate placed at the end of said insertion means substantially in parallel with the upper face of said dielectric resonance element,
wherein said insertion means is adjusted to change a space between said dielectric resonance element and said plate, whereby the resonance frequency is controlled.

11. A dielectric filter comprising:
a metal case;
a dielectric resonance element placed on the internal bottom face of said case through a support;
insertion means inserted in a position located in the upper part of said metal case and corresponding to said dielectric resonance element;
a metal plate placed at the end of said insertion means substantially in parallel with the upper face of said dielectric resonance element; and
a metal ring-shaped material run through said insertion means between the face of said metal case in which said insertion means is inserted and said plate.

12. The dielectric filter according to claim 1, wherein said dielectric material has a relative dielectric constant of 10 or smaller.

13. A communication apparatus comprising a transmission apparatus and a reception apparatus,
wherein at least one of said transmission apparatus and reception apparatus comprises the dielectric filter according to any of claims 1, 5, 9 and 11.

14. A method of controlling a resonance frequency using a dielectric filter comprising:
a metal case having an opening in the upper part;
a metal lid of closing said opening;
a dielectric resonance element placed on the internal bottom face of said case through a support;
insertion means made of dielectric material inserted in a position in said lid corresponding to said dielectric resonance element; and
a metal plate placed at the end of said insertion means substantially in parallel with the upper face of said dielectric resonance element,
wherein the position of said insertion means is adjusted to change the space between said dielectric resonance element and said plate, whereby the resonance frequency is controlled.
